(19) United States
(12) Patent Application Publication
(10) Pub. No.: US 2022/0201518 A1
(43) Pub. Date: Jun. 23, 2022

(54) MEASUREMENT MANAGEMENT METHOD FOR MOBILE COMMUNICATION, AND APPARATUS THEREFOR

(71) Applicant: ELECTRONICS AND TELECOMMUNICATIONS RESEARCH INSTITUTE, Daejeon (KR)

(72) Inventor: Ji Hyung KIM, Daejeon (KR)

(73) Assignee: ELECTRONICS AND TELECOMMUNICATIONS RESEARCH INSTITUTE, Daejeon (KR)

(21) Appl. No.: 17/553,746

(22) Filed: Dec. 16, 2021

(30) Foreign Application Priority Data
Dec. 17, 2020 (KR) 10-2020-0177903
Dec. 3, 2021 (KR) 10-2021-0172048

(51) Int. Cl. H04W 24/08; H04W 72/04; H04W 24/10; H04L 5/00

(52) U.S. Cl. CPC H04W 24/08; H04L 5/0048; H04W 24/10; H04W 72/0453

(57) ABSTRACT

An operation method of a terminal performing CSI-RS measurement may comprise: receiving configuration information for the CSI-RS measurement from a base station; performing switching from a first BWP to a second BWP for the CSI-RS measurement based on the configuration information, and performing the CSI-RS measurement in the second BWP; and performing measurement reporting according to the CSI-RS measurement to the base station in the second BWP and performing switching to the first BWP, or performing switching to the first BWP and performing the measurement reporting according to the CSI-RS measurement to the base station in the first BWP.

### CROSS-REFERENCE TO RELATED APPLICATIONS

This application claims priority to Korean Patent Applications No. 10-2020-0177903, filed on Dec. 17, 2020, and No. 10-2021-0172048 filed on Dec. 3, 2021 with the Korean Intellectual Property Office (KIPO), the entire contents of which are hereby incorporated by reference.

### BACKGROUND

### 1. Technical Field

The present disclosure relates to a technique for managing measurement in a mobile communication system, and more particularly, to a method for managing measurement between a terminal and a base station when a bandwidth part (BWP) switching is performed for the measurement in mobile communication, and an apparatus therefor.

### 2. Related Art

In the 5G new radio (NR) system, a terminal measures a synchronization signal block

(SSB) and/or a channel state information-reference signal (CSI-RS), and reports measured CSI such as a rank indicator (RI), a precoding matrix indicator (PMI), a channel quality indicator (CQI), a reference signal received power (RSRP), and/or the like to a base station. The base station transmits a reference signal (e.g., SSB or CSI-RS) for measurement of the terminal. The terminal receives the reference signal (e.g., SSB or CSI-RS), and reports a value corresponding to ‘report Quantity’ to the base station through measurement of the received reference signal. In this case, the reference signal is basically transmitted within a bandwidth part (BWP) in which the terminal receives a physical downlink shared channel (PDSCH), and the terminal reports CSI measured within the BWP to the base station.

Meanwhile, if a reference signal is configured in a BWP other than the BWP in which the terminal receives a PDSCH, the terminal should perform switching to the corresponding BWP for CSI measurement. In this case, after obtaining measurement values for the reference signal through BWP switching, it may be necessary to determine which BWP to use for the terminal to report the measurement values to the base station.

### SUMMARY

Accordingly, exemplary embodiments of the present disclosure are directed to providing an operation method of a terminal for managing measurement when a BWP switching is performed for the measurement.

Exemplary embodiments of the present disclosure are directed to providing an operation method of a base station for managing measurement of a terminal when a BWP switching is performed for the measurement.

Exemplary embodiments of the present disclosure are directed to providing a configuration of a terminal or base station for managing measurement when a BWP switching is performed for the measurement.

According to a first exemplary embodiment of the present disclosure, an operation method of a terminal performing CSI-RS measurement may comprise: receiving configuration information for the CSI-RS measurement from a base station; performing switching from a first BWP to a second BWP for the CSI-RS measurement based on the configuration information, and performing the CSI-RS measurement in the second BWP; and performing measurement reporting according to the CSI-RS measurement to the base station in the second BWP and performing switching to the first BWP, or performing switching to the first BWP and performing the measurement reporting according to the CSI-RS measurement to the base station in the first BWP.

The configuration information may include an identifier (ID) of a target CSI-RS for the CSI-RS measurement and an ID of the second BWP mapped to the target CSI-RS.

The configuration information may include an ID of a target CSI-RS for the CSI-RS measurement, and an ID of the second BWP may be implicitly determined by the ID of the target CSI-RS.

The configuration information may include a setting value for a timer that determines a period in which the terminal operates in the second BWP, and the timer may start when the switching from the first BWP to the second BWP is performed.

When the timer reaches the setting value, the switching to the first BWP may be performed.

When an uplink transmission until the timer reaches the setting value is not allocated in the second BWP, the switching to the first BWP may be performed regardless of a remaining counter value of the timer.

The first BWP may be an initial BWP or a default BWP.

According to a second exemplary embodiment of the present disclosure, an operation method of a terminal performing CSI-RS measurement may comprise: receiving configuration information for the CSI-RS measurement from a base station; performing switching from a first BWP to a second BWP for the CSI-RS measurement based on the configuration information, and performing the CSI-RS measurement in the second BWP; and performing measurement reporting according to the CSI-RS measurement to the base station in the second BWP; performing switching to a third BWP and performing the measurement reporting according to the CSI-RS measurement to the base station in the third BWP; or performing switching to the third BWP after performing switching to the first BWP, and performing the measurement reporting according to the CSI-RS measurement to the base station in the third BWP.

The first BWP may be an initial BWP or a default BWP.

The second BWP may be a BWP in which beam-management CSI-RS(s) are transmitted by the base station.

The third BWP may be a BWP corresponding to a beam having a highest measurement value among beam management CSI-RS(s) received in the second BWP.

Whether the terminal performs switching from the second BWP to the first BWP or the third BWP may be determined according to a result of the CSI-RS measurement and/or whether the CSI-RS measurement is performed for beam failure recovery.

When the CSI-RS measurement is performed for beam failure recovery, the measurement reporting according to the CSI-RS measurement may be performed through transmission of a random access channel (RACH) preamble to the base station.

According to a third exemplary embodiment of the present disclosure, a terminal performing CSI-RS measurement may comprise: a processor; a memory electronically communicating with the processor; and instructions stored in the memory, wherein when executed by the processor, the instructions cause the terminal to: receive configuration information for the CSI-RS measurement from a base station; perform switching from a first BWP to a second BWP for the CSI-RS measurement based on the configuration information, and perform the CSI-RS measurement in the second BWP; and perform measurement reporting according to the CSI-RS measurement to the base station in the second BWP and perform switching to the first BWP, or perform switching to the first BWP and perform the measurement reporting according to the CSI-RS measurement to the base station in the first BWP.

The configuration information may include an identifier (ID) of a target CSI-RS for the CSI-RS measurement and an ID of the second BWP mapped to the target CSI-RS.

The configuration information may include an ID of a target CSI-RS for the CSI-RS measurement, and an ID of the second BWP may be implicitly determined by the ID of the target CSI-RS.

The configuration information may include a setting value for a timer that determines a period in which the terminal operates in the second BWP, and the timer may start when the switching from the first BWP to the second BWP is performed.

When the timer reaches the setting value, the switching to the first BWP may be performed.

When an uplink transmission until the timer reaches the setting value is not allocated in the second BWP, the switching to the first BWP may be performed regardless of a remaining counter value of the timer.

The first BWP may be an initial BWP or a default BWP.

Using the exemplary embodiments according to the present disclosure as described above, in a situation in which BWP switching is performed for CSI-RS measurement, a BWP in which CSI-RS measurement is performed and a BWP in which CSI measurement reporting is performed can be determined. In addition, when beam failure recovery (BFR) is performed, a BWP in which measurement of beam management CSI-RS(s) is performed and a BWP in which a RACH preamble for the BFR is transmitted may be determined. Accordingly, a BWP in which the terminal operates and a BWP in which the base station expects the terminal to operate may coincide with each other.

### BRIEF DESCRIPTION OF DRAWINGS

FIG. 1 is a conceptual diagram illustrating an exemplary embodiment of a mobile communication system.

FIG. 2 is a block diagram illustrating an exemplary embodiment of a communication node constituting a communication system.

FIG. 3A is a conceptual diagram for describing association between a CSI-RS and a CSI measurement report in a TDD environment, and FIG. 3B is a conceptual diagram for describing association between a CSI-RS and a CSI measurement report in an FDD environment.

FIG. 4A is a conceptual diagram for describing an exemplary embodiment of a CSI measurement reporting method when a BWP for measurement and a BWP for measurement reporting are different from each other, and FIG. 4B is a conceptual diagram for describing another exemplary embodiment of a CSI measurement reporting method when a BWP for measurement and a BWP for measurement reporting are different from each other.

FIGS. 5A to 5C are conceptual diagrams for describing methods to which conditional BWP switching based on a CSI measurement result is applied according to exemplary embodiments of the present disclosure.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, ‘at least one of A and B’ may mean ‘at least one of A or B’ or ‘at least one of combinations of one or more of A and B’. Also, in exemplary embodiments of the present disclosure, ‘one or more of A and B’ may mean ‘one or more of A or B’ or ‘one or more of combinations of one or more of A and B’.

In exemplary embodiments of the present disclosure, ‘(re)transmission’ may mean ‘transmission’, ‘retransmission’, or ‘transmission and retransmission’, (re)configuration' may mean ‘configuration’, ‘reconfiguration’, or ‘configuration and reconfiguration’, ‘(re)connection’ may mean ‘connection’, ‘reconnection’, or ‘connection and reconnection’, and ‘(re-)access’ may mean ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network may be a non-terrestrial network (NTN), a 4G communication network (e.g., long-term evolution (LTE) communication network), a 5G communication network (e.g., new radio (NR) communication network), and/or the like. The 4G communication network and 5G communication network may be classified as terrestrial networks.

The NTN may operate based on the LTE technology and/or NR technology. The NTN may support communication in a frequency band of 6 GHz or above as well as a frequency band of 6 GHz or below. The 4G communication network may support communications in a frequency band of 6 GHz or below. The 5G communication network may support communications not only in a frequency band of 6 GHz or below, but also in a frequency band of 6 GHz or above. A communication network to which exemplary embodiments according to the present disclosure are applied is not limited to the contents described below, and exemplary embodiments according to the present disclosure may be applied to various communication networks. Here, a communication network may be used in the same meaning as a communication system.

Throughout the present disclosure, a ‘network’ may include, for example, a wireless Internet such as Wi-Fi, a portable Internet such as wireless broadband internet (WiBro) or world interoperability for microwave access (WiMax), a 3^{rd} generation (3G) mobile communication network such as global system for mobile communication (GSM), code division multiple access (CDMA), or CDMA2000, a 3.5^{th} generation (3.5G) mobile communication network such as high speed downlink packet access (HSDPA) or high speed uplink packet access (HSUPA), a 4^{th} generation (4G) mobile communication network such as long term evolution (LTE) or LTE-Advanced, a 5^{th} generation (5G) mobile communication network, and/or the like.

Throughout the present disclosure, a ‘terminal’ may refer to an access terminal, mobile station, mobile terminal, station, subscriber station, portable subscriber station, user equipment, access terminal, node, device, and/or the like, and may include all or some functions of the terminal, access terminal, mobile station, mobile terminal, station, subscriber station, portable subscriber station, user equipment, access terminal, node, device, and/or the like.

The terminal may refer to a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video player, or the like that has communication capability and that a mobile communication service user can use.

Throughout the present disclosure, a ‘base station’ may refer to an access point, radio access station, NodeB, evolved NodeB, base transceiver station, access point, access node, road side unit (RSU), digital unit (DU), cloud digital unit (CDU), radio remote head (RRH), radio unit (RU), transmission point (TP), transmission and reception point (TRP), relay node, mobile multi-hop relay-base station (MMR-BS), and/or the like, and may include all or some functions of the base station, access point, radio access station, NodeB, evolved NodeB, base transceiver station, access point, access node, RSU, DU, CDU, RRH, RU, TP, TRP, relay node, MMR-BS, and/or the like.

Hereinafter, exemplary embodiments according to the present disclosure provide measurement methods and apparatuses suitable for mobile communication. Hereinafter, the exemplary embodiments will be described with reference to the 3GPP NR mobile communication system, and the following references [1] to [11] that define the operations of the 3GPP NR mobile communication system may be cited.

Reference [1] 3GPP TS 38.211 V16.2.0, “3rd Generation Partnership Project; Technical Specification Group Radio Access Network; NR; Physical channels and modulation (Release 16)”

Reference [2] 3GPP TS 38.212 V16.2.0, “3rd Generation Partnership Project; Technical Specification Group Radio Access Network; NR; Multiplexing and channel coding (Release 16)”

Reference [3] 3GPP TS 38.213 V16.2.0, “3rd Generation Partnership Project; Technical Specification Group Radio Access Network; NR; Physical layer procedures for data (Release 16)”

Reference [4] 3GPP TS 38.214 V16.2.0, “3rd Generation Partnership Project; Technical Specification Group Radio Access Network; NR; Physical layer procedures for data (Release 16)”

Reference [5] 3GPP TS 38.321 V16.1.0, “3rd Generation Partnership Project; Technical Specification Group Radio Access Network; NR; Medium Access Control (MAC) protocol specification (Release 15)”

Reference [6] 3GPP TS 38.331 V16.1.0, “3rd Generation Partnership Project; Technical Specification Group Radio Access Network; NR; Radio Resource Control (RRC) protocol specification (Release 15)”

Reference [7] 3GPP TS 38.133 V16.4.0, “3rd Generation Partnership Project; Technical Specification Group Radio Access Network; NR; Requirements for support of radio resource management (Release 16)”

Reference [8] 3GPP TS 38.104 V16.4.0, “3rd Generation Partnership Project; Technical Specification Group Radio Access Network; NR; Base Station (BS) radio transmission and reception (Release 16)”

Reference [9] 3GPP TR 38.811 V15.3.0, “3rd Generation Partnership Project; Technical Specification Group Radio Access Network; Study on New Radio (NR) to support non-terrestrial networks (Release 15)”

Reference [10] 3GPP TR 38.821 V16.0.0, “3rd Generation Partnership Project; Technical Specification Group Radio Access Network; Solutions for NR to support non-terrestrial networks (NTN) (Release 16)”

Reference [11] 3GPP TR 22.829 V17.1.0, “3rd Generation Partnership Project; Technical Specification Group Services and System Aspects; Enhancement for Unmanned Aerial Vehicles; Stage 1 (Release 17)”

Hereinafter, a ‘base station’ may be a conventional base station in terrestrial communication or a satellite base station described in References [9] and [10]. In the present disclosure, a ‘satellite’ may represent a transparent high-altitude platform station system (HAPS) or satellite (e.g., low earth orbit (LEO), medium earth orbit (MEO), geostationary equatorial orbit (GEO), etc.), or a regenerative HAPS or satellite (e.g., LEO, MEO, GEO, etc.). As described in References [9] and [10], the transparent HAPS or satellite may perform a role of a relay for a base station, and the regenerative HAPS or satellite may perform a role of a base station. For convenience of description, the ‘satellite base station’ may be used as a term representing a non-terrestrial base station or a mobile base station. In addition, in the exemplary embodiments described below, the ‘satellite’ may include an unmanned aerial vehicle (UAV) described in Reference [11].

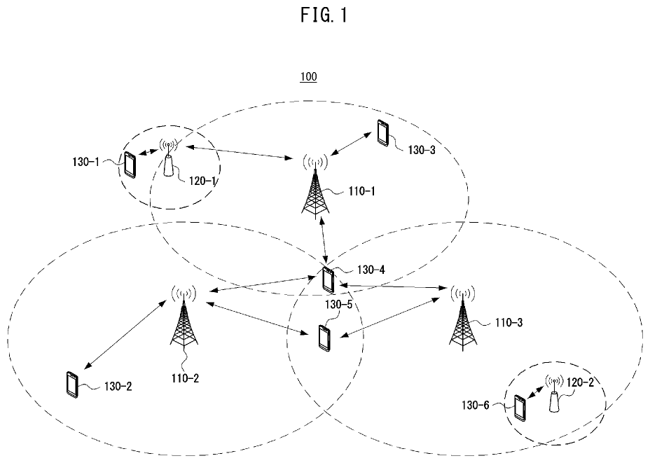

FIG. 1 is a conceptual diagram illustrating an exemplary embodiment of a mobile communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4^{th} generation (4G) communication (e.g., long term evolution (LTE), LTE-advanced (LTE-A)), 5^{th} generation (5G) communication (e.g., new radio (NR)), or the like. The 4G communication may be performed in a frequency band of 6 GHz or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

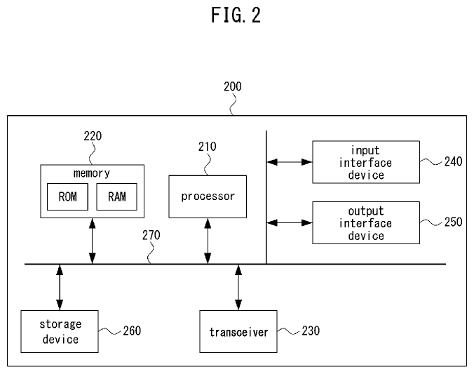

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), base transceiver station (BTS), radio base station, radio transceiver, access point, access node, road side unit (RSU), radio remote head (RRH), transmission point (TP), transmission and reception point (TRP), eNB, gNB, or the like. Here, each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of things (IoT) device, mounted apparatus (e.g., a mounted module/device/terminal or an on-board device/terminal, etc.), or the like.

Each of the plurality of communication nodes 110-1, 110-2, 110-3, 120-1, 120-2, 130-1, 130-2, 130-3, 130-4, 130-5, and 130-6 may support cellular communication (e.g., LTE,

LTE-Advanced (LTE-A), etc.) defined in the 3rd generation partnership project (3GPP) specification. Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

A terminal measures a synchronization signal block (SSB) and/or a channel state information-reference signal (CSI-RS), and reports measured CSI such as a rank indicator (RI), a precoding matrix indicator (PMI), a channel quality indicator (CQI), a reference signal received power (RSRP), and/or the like to a base station. The base station transmits a reference signal (e.g., SSB or CSI-RS) for measurement of the terminal.

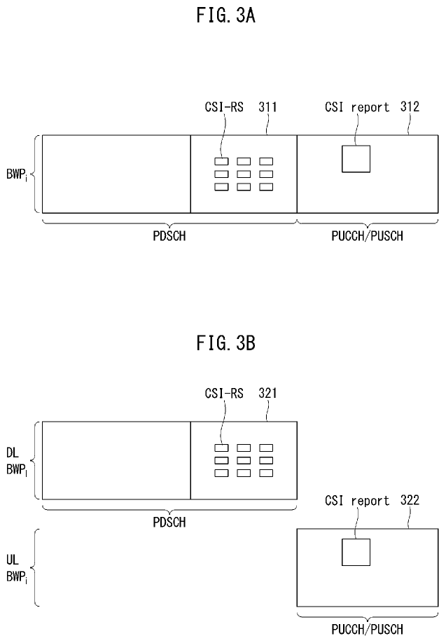

FIG. 3A is a conceptual diagram for describing association between a CSI-RS and a CSI measurement report in a TDD environment, and FIG. 3B is a conceptual diagram for describing association between a CSI-RS and a CSI measurement report in an FDD environment.

Referring to FIG. 3A, a BWP 311 in which the terminal receives a CSI-RS from the base station may be associated with a BWP 312 in which the terminal performs CSI measurement reporting to the base station. That is, in a time division duplex (TDD) environment, a BWP for receiving a CSI-RS may be the same BWP (e.g., BWPi (i is an BWP index)) as a BWP for performing CSI measurement reporting. Referring to FIG. 3B, in a frequency division duplex (FDD) environment, a BWP (i.e., downlink BWPi 321) in which the terminal receives a CSI-RS from the base station may be associated with a BWP (i.e., uplink BWPi 322) in which the terminal performs CSI measurement reporting to the base station.

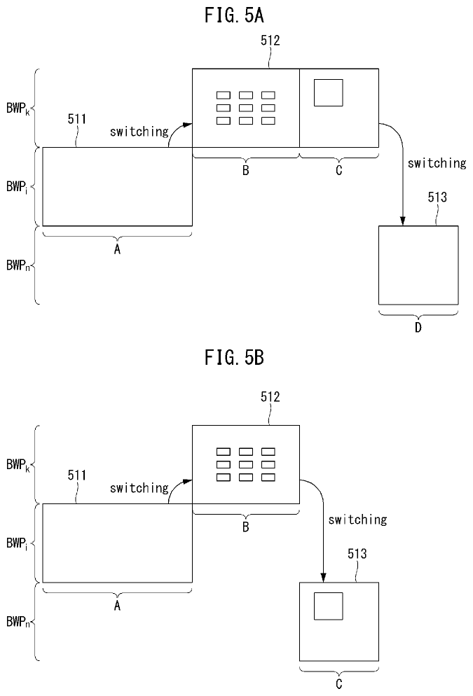

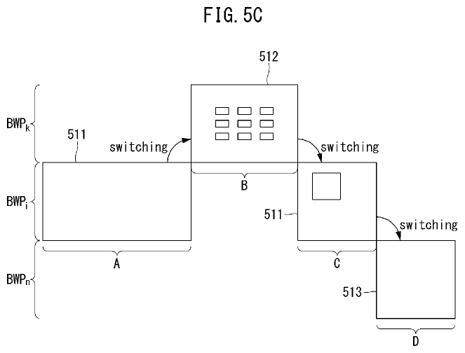

The above-described association between the BWP(s) may be equally applied to an SSB and an SSB measurement reporting. Exemplary embodiments of the present disclosure will be mainly described for CSI-RS and CSI (or CSI-RS) measurement reporting. The CSI measurement report may include the above-described CRI, RI, PMI, CQI, RSRP, and/or the like. Meanwhile, in the present disclosure, the ‘CSI (or, CSI-RS) measurement reporting’ may be not a ‘transmission of a CSI-RS measurement report to the base station’, but a transmission of a random access channel (RACH) preamble according to a result of CSI-RS measurement (i.e., a situation of ‘beam failure recovery (BFR)’ to be described later with reference to FIGS. 5A and 5B). In this case, according to the result of the CSI-RS (i.e., beam management CSI-RS) measurement, the terminal may transmit a RACH preamble, not a CSI measurement report, to the base station. A BWP of a RACH occasion for transmitting the RACH preamble may also be associated with a BWP of the CSI-RS. Therefore, hereinafter, ‘performing CSI measurement reporting’ may be a concept including ‘transmission of a CSI measurement report’ or ‘transmission of a RACH preamble’.

CSI_Measurement Configuration Considering BWP Switching

In exemplary embodiments of the present disclosure, a method for associating resources for measurement (e.g., CSI-RS or SSB) with resources for performing CSI measurement reporting (e.g., CSI-Report or SSB-Report) in consideration of a case of performing BWP switching for measurement will be described. Although exemplary embodiments below are mainly described in the TDD environment, the same may be applied to the FDD environment. Basically, two schemes may be supported.

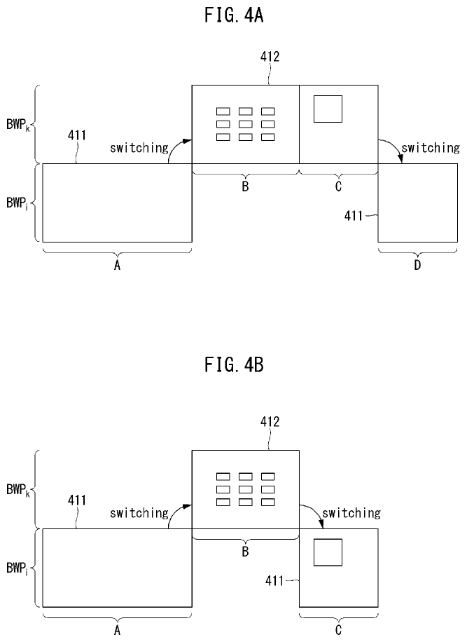

FIG. 4A is a conceptual diagram for describing an exemplary embodiment of a CSI measurement reporting method when a BWP for measurement and a BWP for measurement reporting are different from each other, and FIG. 4B is a conceptual diagram for describing another exemplary embodiment of a CSI measurement reporting method when a BWP for measurement and a BWP for measurement reporting are different from each other.

FIG. 4A illustrates an exemplary embodiment in which the terminal performs switching to a second BWP (i.e., BWPk 412) while performing transmission and reception with the base station in a first BWP (i.e., BWPi 411), performs CSI-RS reception and measurement in the second BWP 412, performs CSI-measurement reporting according to the measurement, and performs switching to the first BWP 411. FIG. 4B illustrates an exemplary embodiment in which the terminal performs switching to the second BWP (i.e., BWPk 412) while performing transmission and reception with the base station in the first BWP (i.e., BWPi 411), performs CSI-RS reception and measurement in the second BWP 412, performs switching to the first BWP 411, and performs CSI-measurement reporting in the first BWP 411.

In FIGS. 4A and 4B, a period A may be a period for transmitting and receiving a physical downlink control channel (PDCCH), physical downlink shared channel (PDSCH), physical uplink control channel (PUCCH), and/or physical uplink shared channel (PUSCH), a period B may be a period for transmitting and receiving a PDSCH including a CSI-RS, a period C may be a period for transmitting and receiving a PUCCH or PUSCH including a CSI measurement report, and a period D may be a period for transmitting and receiving a PDCCH, PDSCH, PUCCH, and/or PUSCH.

In order to support the schemes of FIGS. 4A and 4B, a plurality of BWP-inactiveTimers may be configured. In the current NR system, a setting value of the BWP-inactiveTimer is included in ServingCellconfig and configured by the base station to the terminal, and may be configured as one value. When the terminal receives a BWP switching indication on a PDCCH indicating downlink resource allocation or uplink grant, the terminal may start the BWP-inactiveTimer when performing a BWP switching according to the BWP switching indication. While staying in the BWP switched by the BWP switching, the terminal may perform counting for the BWP-inactiveTimer, and when a value of BWP-inactiveTimer reaches the setting value of the BWP-inactiveTimer, switching to a default BWP or initial BWP may be performed again.

Since the BWP switching may be performed in various situations, exemplary embodiments of the present disclosure propose methods of configuring a separate BWP-inactiveTimer for CSI measurement management. To this end, a parameter (e.g., BWP-inactivTimer_Meas parameter) for such the BWP timer for measurement management may be added to RRC parameters (e.g., CSI-MeasConfig or BeamFailureRecoveryConfig, etc.) for measurement management. The terminal may receive the RRC parameters for measurement management. The terminal may start the BWP-inactiveTimer when performing switching to a BWP for measurement (and/or measurement reporting), and when the BWP-inactiveTimer reaches a setting value indicated by the BWP-inactivTimer_Meas parameter, the terminal may perform switching to the default BWP again. On the other hand, if the default BWP is not configured, when the BWP-inactiveTimer reaches the setting value indicated by the BWP-inactivTimer_Meas parameter, the terminal may perform switching to the initial BWP.

Meanwhile, when BWP switching is performed for measurement, if a PUCCH or PUSCH for uplink transmission is allocated before the BWP-inactiveTimer reaches the setting value indicated by the BWP-inactivTimer_Meas parameter, a terminal operating in the TDD mode may perform uplink transmission in the switched BWP. When BWP switching is performed for measurement, a terminal operating in the FDD mode may not perform switching of a downlink BWP. The base station may configure the scheme of FIG. 4A or 4B by setting the value of the BWP-inactivTimer_Meas parameter.

On the other hand, in the exemplary embodiment of FIG. 4B, if uplink transmission is not allocated to the switched BWP until the BWP-inactiveTimer reaches the setting value indicated by the BWP-inactivTimer_Meas parameter, the terminal may perform switching to the default or initial BWP described above, and then perform the corresponding CSI measurement reporting. Alternatively, if uplink transmission (e.g., PUCCH or PUSCH) is not allocated to the switched BWP until the BWP-inactiveTimer reaches the setting value indicated by the BWP-inactivTimer_Meas parameter, the terminal may perform switching to the default or initial BWP described above, and then perform the CSI measurement reporting regardless of the remaining value of the BWP-inactiveTimer (i.e., regardless of whether the BWP-inactiveTimer reaches the setting value indicated by the BWP-inactivTimer_Meas parameter).

In this case, a CSI-RS ID may be mapped to a CSI-Report ID. Since the same BWP ID is basically configured, the terminal may identify a BWP for receiving a CSI-RS and a BWP for transmitting a CSI measurement report only by mapping the CSI-RS ID. However, when different BWP IDs are used for the BWP for receiving a CSI-RS and the BWP for transmitting a CSI measurement report, the terminal may not discriminate the BWPs using only the CSI-RS ID. That is, since a CSI-RS ID and a CSI-report ID are allocated for each

BWP, the same CSR-RS ID or CSI-report ID may be configured for different BWPs. In order to prevent the above-described problem, a CSI-RS ID and a BWP ID mapped to the CSI-RS ID may be explicitly or implicitly configured. Here, the CSI-RS ID may be CSI-ResourceConfigId, NZP-CSI-RS-ResourceSetId, CSI-IM-ResourceSetld, NZP-CSI-RS-Resourceld, or the like.

As an explicit scheme for mapping a CSI-RS ID to a BWP ID, the base station may signal a CSI-RS ID and a BWP ID mapped to the CSI-RS ID to the terminal by including the CSI-RS ID and the BWP ID mapped to the CSI-RS ID in CSI-Report configuration parameters (e.g., CSI-ReportConfig). Through this, the terminal and the base station may determine for which CSI-RS a measurement report is, and may determine in which BWP the CSI-RS is transmitted.

As an implicit scheme for mapping a CSI-RS ID to a BWP ID, a relationship between a CSI-RS ID and a BWP ID may be implicitly configured, or a CSI-RS ID independent of a BWP ID may be configured. The base station may allocate a specific CSI-RS ID only to a specific BWP, so that the terminal and the base station can implicitly identify a BWP ID mapped to a CSI-RS ID without including information on an explicit relationship between the CSI-RS ID and the BWP ID in the CSI-Report configuration parameters. To this end, a mapping relationship between a specific CSI-RS ID and a specific BWP may be configured as an RRC parameter.

For a CSI-RS for beam failure recovery (BFR), the CSI-RS may be associated with a RACH occasion. Since a CSI-RS ID and a RACH occasion for different BWPs may be associated with each other even in this case, a CSI-RS ID and a BWP associated with the CSI-RS ID may be included in BearnFailureRecoveryConfig, etc. that is an RRC parameter, as described above. Alternatively, a specific CSI-RS ID may be allocated only to a specific BWP.

For the schemes of FIGS. 4A and 4B, when a CSI-RS (e.g., CSI-RS configured by CSI-MeasConfig or BearnFailureRecoveryConfig) is a periodic or semi-persistent CSI-RS for CSI measurement, the corresponding CSI measurement report may be configured in a configured grant (CG) scheme. In this case, a configuredGrantConfig_Meas may be configured within an rrc-ConfiguredUplinkGrant according to a CG type 1 or a configuredGrantConfig_Meas may be configured in an rrc-ConfiguredUplinkGrant according to a CG type 2. By including the CSI measurement report configuration parameters in the configuredGrantConfig_Meas, a CSI-RS ID and a BWP ID explicitly mapped to the CSI-RS ID may be configured as described above. Alternatively, when RRC parameters for allocating a specific CSI-RS ID only to a specific BWP are configured, the base station may include only the CSI-RS ID in the CSI measurement report configuration parameters.

In addition, a BWP ID of a BWP for performing CSI measurement reporting of the terminal may be included in configuredGrantConfig_Meas. If the BWP ID for performing the CSI measurement reporting of the terminal is not included in configuredGrantConfig_Meas, the terminal may basically perform switching to the default or initial BWP, and then may transmit a measurement report for measurement values as in the exemplary embodiment of FIG. 4B. When the BWP ID of the BWP for performing the CSI measurement reporting of the terminal is explicitly included in configuredGrantConfig_Meas, if the BWP ID included explicitly is the same as a BWP ID of the BWP switched for measurement, the terminal may transmit a measurement report in the corresponding BWP as in the exemplary embodiment of FIG. 4A.

When a terminal operating in the FDD mode performs BWP switching for measurement, it may be determined whether or not to perform the same switching for uplink BWP. As described above, when parameter(s) for uplink transmission are not configured in the switched BWP, the uplink BWP may not be switched. Alternatively, switching may not be performed when the BWP-inactiveTimer_Meas parameter is configured and the corresponding setting value is less than a time remaining until the CSI measurement reporting is performed. Alternatively, when configuredGrantConfig_Meas is configured and the BWP ID of the BWP for performing the CSI measurement reporting of the terminal is not configured, or when the BWP ID is configured, but it is different from the BWP ID of the switched BWP or the CSI-RS ID for measurement, the switching may not be performed.

Meanwhile, periodic configuration may be applied to the exemplary embodiments of FIGS. 4A and 4B. The base station may periodically or semi-persistently configure BWP ID(s) for each of CSI measurement and CSI measurement reporting in the RRC parameters for measurement management (e.g., CSI-MeasConfig or BeamFailureRecoveryConfig, etc.). In this case, the BWP-inactiveTimer_Meas parameter may not need to be configured, and the terminal may periodically perform CSI-RS reception and measurement in BWP(s) indicated by the BWP ID(s) for CSI measurement, and may periodically perform CSI measurement reporting in BWP(s) indicated by the BWP ID(s) for CSI measurement reporting.

Conditional BWP Switching for CSI Reporting

FIGS. 5A to 5C are conceptual diagrams for describing methods to which conditional BWP switching based on a CSI measurement result is applied according to exemplary embodiments of the present disclosure.

Referring to FIGS. 5A to 5C, a terminal operating in a first BWP 511 (i.e., BWPi) may perform switching to a second BWP 512 (i.e., BWPk) for CSI measurement, and perform CSI measurement in the second BWP 512. The terminal perform switch to the first BWP 511 or a third BWP 513 (i.e., BWPn) according to a result of the CSI measurement in the second BWP 512.

For example, when beams and BWPs are respectively associated with each other, in a beam failure recovery (BFR) procedure, the terminal may measure CSI-RSs for beam management in a section B of the second BWP 512. If a measurement value (e.g., L1-RSRP or L1-SINR) for a beam corresponding to the third BWP 513 has the largest value, the terminal may perform switching to the third BWP 513, and perform data transmission and reception while monitoring a response (e.g., PDCCH) according to the BFR of the base station.

To this end, three types of exemplary embodiments may be considered as follows.

In the case shown in FIG. 5A, the terminal may perform CSI measurement in the second BWP 512, perform CSI measurement reporting (e.g., RACH preamble transmission in the case of BFR) also in the second BWP 512, and perform switching to the third BWP 513 instead of the first BWP 511.

In the case shown in FIG. 5B, the terminal may perform CSI measurement in the second BWP 512, and perform switching to the third BWP 513 in order to perform CSI measurement reporting in the third BWP 513.

In the case shown in FIG. 5C, the terminal may perform CSI measurement in the second BWP 512, perform switching to the first BWP 511, perform CSI measurement reporting in the first BWP 511, and then perform switching to the third BWP 513.

Which BWP (e.g., first BWP or third BWP) the terminal switches from the second BWP 512 in which the CSI measurement is performed may be determined by the measurement situation (e.g., CSI-RS measurement according to BFR) and/or the measurement result (e.g., L1-RSRP or L1-SINR). Detailed condition(s) for performing switching from the second BWP 512 to the first BWP 511 or the third BWP 513 may follow the condition(s) described with reference to FIGS. 4A and 4B (i.e., timer configuration or whether uplink transmission is assigned or not).

On the other hand, based on a resource (e.g., PUCCH or PUSCH, or RACH occasion) for the CSI measurement reporting configured to the terminal, the base station may receive the CSI measurement report (i.e., CSI measurement value(s) or RACH preamble) of the terminal by monitoring the BWP in which the terminal performs the CSI measurement reporting. In the case of BFR, the base station may estimate a BWP mapped to a beam by detecting a preamble on a RACH occasion mapped to the beam, and may identify the BWP to which the terminal has switched. In the exemplary embodiments shown in FIGS. 5A or 5C, the terminal may transmit a contention-free random access (CFRA) RACH preamble or a contention-based random access (CBRA) RACH preamble according to the RACH occasion allocated by the base station. In the exemplary embodiment shown in FIG. 5B, the terminal may transmit a CBRA RACH preamble.

The exemplary embodiments of the present disclosure may be implemented as program instructions executable by a variety of computers and recorded on a computer readable medium. The computer readable medium may include a program instruction, a data file, a data structure, or a combination thereof The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal performing channel state information-reference signal (CSI-RS) measurement, the operation method comprising:
receiving configuration information for the CSI-RS measurement from a base station;
performing switching from a first bandwidth part (BWP) to a second BWP for the CSI-RS measurement based on the configuration information, and performing the CSI-RS measurement in the second BWP; and
performing measurement reporting according to the CSI-RS measurement to the base station in the second BWP and performing switching to the first BWP, or performing switching to the first BWP and performing the measurement reporting according to the CSI-RS measurement to the base station in the first BWP.

2. The operation method according to claim 1, wherein the configuration information includes an identifier (ID) of a target CSI-RS for the CSI-RS measurement and an ID of the second BWP mapped to the target CSI-RS.

3. The operation method according to claim 1, wherein the configuration information includes an ID of a target CSI-RS for the CSI-RS measurement, and an ID of the second BWP is implicitly determined by the ID of the target CSI-RS.

4. The operation method according to claim 1, wherein the configuration information includes a setting value for a timer that determines a period in which the terminal operates in the second BWP, and the timer starts when the switching from the first BWP to the second BWP is performed.

5. The operation method according to claim 4, wherein when the timer reaches the setting value, the switching to the first BWP is performed.

6. The operation method according to claim 4, wherein when an uplink transmission until the timer reaches the setting value is not allocated in the second BWP, the switching to the first BWP is performed regardless of a remaining counter value of the timer.

7. The operation method according to claim 1, wherein the first BWP is an initial BWP or a default BWP.

8. An operation method of a terminal performing channel state information-reference signal (CSI-RS) measurement, the operation method comprising:
receiving configuration information for the CSI-RS measurement from a base station;
performing switching from a first bandwidth part (BWP) to a second BWP for the CSI-RS measurement based on the configuration information, and performing the CSI-RS measurement in the second BWP; and
performing measurement reporting according to the CSI-RS measurement to the base station in the second BWP; performing switching to a third BWP and performing the measurement reporting according to the CSI-RS measurement to the base station in the third BWP; or performing switching to the third BWP after performing switching to the first BWP, and performing the measurement reporting according to the CSI-RS measurement to the base station in the third BWP.

9. The operation method according to claim 8, wherein the first BWP is an initial BWP or a default BWP.

10. The operation method according to claim 8, wherein the second BWP is a BWP in which beam-management CSI-RS(s) are transmitted by the base station.

11. The operation method according to claim 10, wherein the third BWP is a BWP corresponding to a beam having a highest measurement value among beam management CSI-RS(s) received in the second BWP.

12. The operation method according to claim 8, wherein whether the terminal performs switching from the second BWP to the first BWP or the third BWP is determined according to a result of the CSI-RS measurement and/or whether the CSI-RS measurement is performed for beam failure recovery.

13. The operation method according to claim 8, wherein when the CSI-RS measurement is performed for beam failure recovery, the measurement reporting according to the CSI-RS measurement is performed through transmission of a random access channel (RACH) preamble to the base station.

14. A terminal performing channel state information-reference signal (CSI-RS) measurement, the terminal comprising:
a processor;
a memory electronically communicating with the processor; and
instructions stored in the memory,
wherein when executed by the processor, the instructions cause the terminal to:
receive configuration information for the CSI-RS measurement from a base station;
perform switching from a first bandwidth part (BWP) to a second BWP for the CSI-RS measurement based on the configuration information, and perform the CSI-RS measurement in the second BWP; and
perform measurement reporting according to the CSI-RS measurement to the base station in the second BWP and perform switching to the first BWP, or perform switching to the first BWP and perform the measurement reporting according to the CSI-RS measurement to the base station in the first BWP.

15. The terminal according to claim 14, wherein the configuration information includes an identifier (ID) of a target CSI-RS for the CSI-RS measurement and an ID of the second BWP mapped to the target CSI-RS.

16. The terminal according to claim 14, wherein the configuration information includes an ID of a target CSI-RS for the CSI-RS measurement, and an ID of the second BWP is implicitly determined by the ID of the target CSI-RS.

17. The terminal according to claim 14, wherein the configuration information includes a setting value for a timer that determines a period in which the terminal operates in the second BWP, and the timer starts when the switching from the first BWP to the second BWP is performed.

18. The terminal according to claim 17, wherein when the timer reaches the setting value, the switching to the first BWP is performed.

19. The terminal according to claim 17, wherein when an uplink transmission until the timer reaches the setting value is not allocated in the second BWP, the switching to the first BWP is performed regardless of a remaining counter value of the timer.

20. The terminal according to claim 14, wherein the first BWP is an initial BWP or a default BWP.
